(19) United States
(12) Patent Application Publication
(10) Pub. No.: US 2014/0314953 A1
(43) Pub. Date: Oct. 23, 2014

(54) COATING DEVICE AND COATING METHOD

(71) Applicant: Sung Hune YOO, Yongin-City (KR)

(72) Inventor: Sung Hune YOO, Yongin-City (KR)

(21) Appl. No.: 14/074,974

(22) Filed: Nov. 8, 2013

(30) Foreign Application Priority Data
Apr. 17, 2013 (KR) 10-2013-0042347

(51) Int. Cl. B05D 1/34

(52) U.S. Cl. CPC B05D 1/34
USPC 427/256

(57) ABSTRACT

A coating method includes arranging a nozzle portion with a plurality of nozzles above a substrate with a plurality of coating areas, moving the substrate or the nozzle portion in a first direction, and applying a coating liquid to respective coating areas through corresponding nozzles.

### CROSS-REFERENCE TO RELATED APPLICATIONS

The present application claims priority under 35 U.S.C. §119 to Korean Patent Application No. 10-2013-0042347, filed on Apr. 17, 2013, in the Korean Intellectual Property Office, and entitled: “Coating Device and Coating Method,” which is incorporated by reference herein in its entirety.

### BACKGROUND

1. Field

Example embodiments relate to a coating device and to a coating method.

2. Description of the Related Art

A coating process may be applied to manufacture various products, e.g., semiconductor devices, display devices, solar cells, etc. For example, in the case of forming a polymer organic light emitting layer that is included in an organic light emitting display, a coating liquid may be applied to a substrate using ink jet printing or the like.

### SUMMARY

Example embodiments provide a coating device with a plurality of nozzles corresponding to a plurality of coating areas on a substrate, so the coating device selectively applies a coating liquid to the plurality of coating areas.

Example embodiments also provide a coating method for selectively applying a coating liquid to a plurality of coating areas on a substrate using a plurality of nozzles corresponding to the plurality of coating areas.

In one aspect of the example embodiments, there is provided a coating device including a support portion configured to support a substrate, a nozzle portion configured to apply a coating liquid to the substrate, the nozzle portion including a plurality of parallel nozzles spaced apart from each other in a first direction and configured to discharge the coating liquid, and a transport portion configured to move the support portion or the nozzle portion in the first direction.

The substrate may include a plurality of coating areas arranged in a matrix pattern, the matrix pattern having columns in the first direction and rows in a second direction perpendicular to the first direction, and a number of nozzles in the nozzle portion may be equal to or larger than a number of rows in the matrix pattern.

The number of nozzles may be equal to a number of coating areas.

The plurality of nozzles may be arranged to correspond to a shape of an arrangement of the plurality of coating areas.

The number of nozzles may be equal to the number of rows in the matrix pattern, the nozzle including a discharge port corresponding to the coating area.

The coating device may further include a control portion configured to control the support portion, the nozzle portion, and the transport portion, the control portion being configured to control application of the coating liquid from the nozzles to corresponding coating areas.

The control portion may be configured to control the respective nozzles to descend and to apply the coating liquid to the respective coating areas if the respective nozzles that correspond to the respective coating areas overlap the respective coating areas.

The nozzle portion may be configured to apply the coating liquid to all the coating areas at the same time.

In another aspect of the example embodiments, there is provided a coating a coating device, including a support portion configured to support a substrate, the substrate including a plurality of coating areas, a nozzle portion configured to apply a coating liquid to the substrate through a plurality of nozzles, a number of the nozzles being equal to a number of the coating areas, and a transport portion configured to move the support portion or the nozzle portion in a first direction.

The plurality of nozzles may be arranged to correspond to a shape of an arrangement of the plurality of coating areas.

The plurality of coating areas and the plurality of nozzles may be arranged in a same matrix pattern.

The plurality of coating areas may be arranged in a matrix pattern having columns in the first direction and rows in a second direction perpendicular to the first direction, the nozzle portion being configured to apply the coating liquid to all the coating areas at the same time.

The coating device may further include a control portion configured to control the support portion, the nozzle portion, and the transport portion, the control portion being configured to control nozzles that correspond to respective coating areas to apply the coating liquid to the respective coating areas.

The control portion may be configured to control the respective nozzles to descend and to apply the coating liquid to the respective coating areas if the respective nozzles that correspond to the respective coating areas overlap the respective coating areas.

In yet another aspect of the example embodiments, there is provided a coating method including arranging a nozzle portion with a plurality of nozzles above a substrate with a plurality of coating areas, moving the substrate r the nozzle portion in a first direction, and applying a coating liquid to respective coating areas through corresponding nozzles.

The plurality of coating areas may be arranged in a matrix pattern having columns in the first direction and rows in a second direction perpendicular to the first direction, a number of nozzles being equal to or larger than a number of the rows in the matric pattern.

The number of nozzles may be equal to the number of the coating areas.

The number of nozzles may be equal to the number of the in the matric pattern, the nozzle including a discharge port corresponding to the coating area.

Applying the coating liquid may include descending the nozzles toward the coating areas, and applying the coating liquid to the respective coating areas if the respective nozzles that correspond to the respective coating areas overlap the respective coating areas.

Applying the coating liquid may include applying the coating liquid to all the coating areas at the same time.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of a coating device according to an embodiment;

FIG. 2 illustrates a plan view of a substrate to which a coating liquid is applied by the coating device of FIG. 1;

FIG. 3 illustrates a block diagram schematically illustrating the configuration of the coating device of FIG. 1;

FIGS. 4 to 8 illustrate side views of stages in a coating method according to an embodiment;

FIG. 9 illustrates a perspective view of a coating device according to another embodiment;

FIG. 10 illustrates an enlarged perspective view of a nozzle of the coating device of FIG. 9;

FIG. 11 illustrates a perspective view of a coating device according to still another embodiment; and

FIGS. 12 to 14 illustrate side views of stages in a coating method according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Like reference numerals refer to like elements throughout.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

A “coating device” described in the description may comprehensively refer to all devices that apply a coating material in liquid or semi-solid state to a coated body. In an exemplary embodiment, the coated body may be a substrate that is used in a semiconductor, a display device, or a solar cell, and the coating material may be a polymer organic material, but is not limited thereto. The coated body and the coating material may be diversely selected. In the following description, a substrate exemplifies the coated body, and a coating liquid exemplifies the coating material, but is not limited thereto.

Further, a “coating method” described in the description may comprehensively refer to all methods for applying a coating material using the “coating device,” but is not limited thereto.

Hereinafter, preferred embodiments will be described with reference to the accompanying drawings.

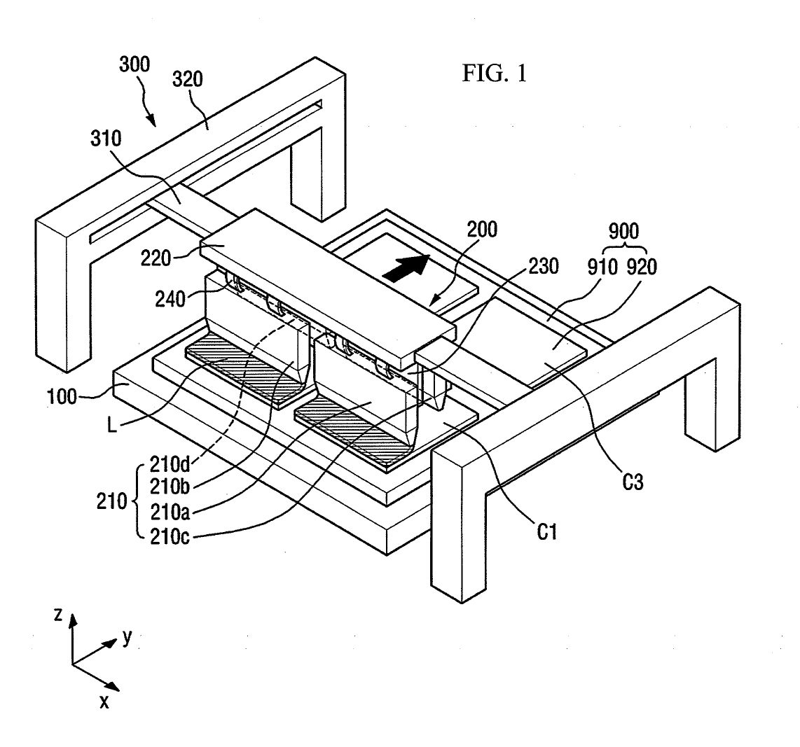

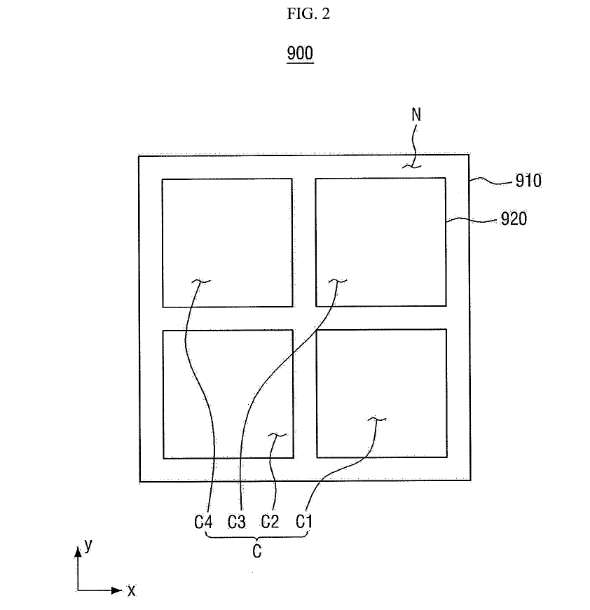

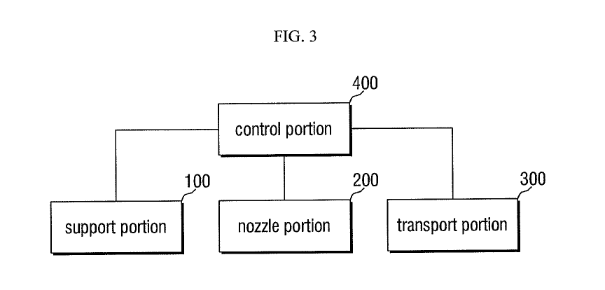

FIG. 1 illustrates a perspective view of a coating device according to an embodiment. FIG. 2 is a plan view of a substrate 900 to which a coating liquid L is applied by the coating device of FIG. 1. FIG. 3 is a block diagram schematically illustrating the configuration of the coating device of FIG. 1.

Referring to FIGS. 1 to 3, a coating device according to an embodiment may include a support portion 100, a nozzle portion 200, and a transport portion 300. Further, the coating device according to an embodiment may include a control portion 400.

Referring to FIG. 1, the support portion 100 may support the substrate 900. That is, the support portion 100 may provide a place where the substrate 900 is seated. The support portion 100 may be, e.g., a stage or a transport rail of an apparatus for fabricating a display device. The support portion 100 may be, e.g., in a cubic plate shape. Further, a width of the support portion 100 may be equal to or larger than a width of the substrate 900. Further, in order to minimize friction between the support portion 100 and the substrate 900, the support portion 100 may be coated with fluorine or Teflon. The substrate 900 may be seated on the support portion 100 by a transport robot, other transport rails, or manual operation of a worker. The substrate 900 that is seated on the support portion 100 may be adsorbed and fixed to the support portion 100 by a vacuum pump that is connected to the support portion 100.

Although not illustrated in the drawing, the coating device according to an embodiment may further include at least one lift bar, which makes the substrate 900 ascend, i.e., to separate the substrate 900 from the support portion 100, or descend, i.e., to seat the substrate 900 on the support portion 100. In this case, if the lift bar ascends, the substrate 900 is arranged at an end portion of the lift bar. If the lift bar descends, the substrate 900 is seated on one surface of the support portion 100.

Referring to FIG. 2, the substrate 900 may include a base substrate 910 and a device layer 920. The base substrate 910 may be in a quadrangular, e.g., square, plate shape. The base substrate 910 may be a rigid substrate, but is not limited thereto, e.g., the base substrate 910 may be a flexible substrate. If the base substrate 910 is a rigid substrate, it may be made of transparent glass. If the base substrate 910 is a flexible substrate, it may be made of plastic having superior heat-resistance and durability, e.g., polyethylene terephthalate, polycarbonate, polyarylate, polyether imide, polyether sulfone, and polyimide. The device layer 920 may be positioned on the base substrate 910. The device layer 920 may include various devices, e.g., a thin film transistor (not illustrated), a capacitor (not illustrated), and the like. The device layer 920 may be formed on the base substrate 910 by a deposition process or the like.

As illustrated in FIG. 2, the substrate 900 may include a coating area C and a non-coating area N. Here, the coating area C may be an area to which the coating liquid L is applied by the coating device according to an embodiment, and the non-coating area N may be an area to which the coating liquid L is not applied by the coating device according to an embodiment. The coating area C may be surrounded by the non-coating area N. Further, the device layer 920 may be positioned on the coating area C. That is, the device layer 920 and the coating area C may completely overlap each other.

A plurality of coating areas C may be provided. For example, the plurality of coating areas C may be in a rectangular shape in plan view. In an exemplary embodiment, the sizes of the plurality of coating areas C may be equal to each other, but are not limited thereto, e.g., a size of at least one coating area C may be different from a size of the remaining coating areas C. Further, in the plurality of coating areas C, a gap distance between two adjacent coating areas C may be equal to each other, but is not limited thereto.

For example, the plurality of coating areas C may be arranged in the form of a matrix. For example, the support portion 100 or the nozzle portion 200 may be moved in one direction (arrow direction in an exemplary embodiment illustrated in FIG. 1) by the transport portion 300, and the plurality of coating areas C may be arranged in the form of a matrix having rows that are perpendicular to the one direction and columns that are parallel to the one direction. In an exemplary embodiment illustrated in FIG. 2, the plurality of coating areas C may be in the form of a 2×2 matrix, but are not limited thereto. That is, the plurality of coating areas C may be in the form of an n×m matrix (where, n and m are natural numbers). For example, as illustrated in FIG. 2, the plurality of coating areas C may include a first coating area C1, a second coating area C2, a third coating area C3, and a fourth coating area C4. The first coating area C1 and the second coating area C2 may be positioned in the same row, i.e., along the x axis. The third coating area C3 and the fourth coating area C4 may be positioned in the same row. Further, the first coating area C1 and the third coating area C3 may be positioned in the same column, i.e., along the y-axis. The second coating area C2 and the fourth coating area C4 may be positioned in the same column. As described above, in the exemplary embodiment illustrated in FIG. 2, four coating areas C that are arranged in a 2×2 matrix form are exemplified, but the example embodiments are not limited thereto.

Referring again to FIG. 1, the nozzle portion 200 may be positioned on the support portion 100. The nozzle portion 200 may be positioned to be spaced apart from the support portion 100 by a predetermined distance. The substrate 900 may be interposed between the nozzle portion 200 and the support portion 100. Here, the substrate 900 may be in contact with the support portion 100, but may be spaced apart from the nozzle portion 200 without being in contact with the nozzle portion 200. The nozzle portion 200 may apply the coating liquid L to the coating area C of the substrate 900, while the nozzle portion 200 is moved in one direction. The nozzle portion 200 may include a nozzle 210, a support plate 220, a height adjuster 230, and a supply pipe 240.

The nozzle 210 may discharge the coating liquid L onto one surface of the substrate 900. In detail, the nozzle 210 may selectively discharge the coating liquid L onto the coating area C of the substrate 900. The nozzle 210 may be a slit nozzle, but is not limited thereto, e.g., the nozzle 210 may be a multi-hole nozzle. The nozzle 210 may be formed to extend in a predetermined direction. In an exemplary embodiment illustrated in FIG. 1, the nozzle 210 is a slit nozzle extending in the x-axis direction. The extended length of the nozzle 210 corresponds to the width of the coating area C. In an exemplary embodiment illustrated in FIG. 1, the length of the nozzle 210 that is measured in the x-axis direction may be equal to or larger than the width of the coating area C that is measured in the x-axis.

A plurality of nozzles 210 may be provided. The support portion 100 or the nozzle portion 200 may be moved in one direction (arrow direction in an exemplary embodiment illustrated in FIG. 1) by the transport portion 300, and the plurality of nozzles 210 may be arranged in parallel in the one direction. Further, a plurality of coating areas C on the substrate may be arranged in the form of a matrix having rows that are perpendicular to the one direction and columns that are parallel to the one direction. That is, as illustrated in FIG. 1, the plurality of coating areas C may be arranged in matrix pattern having rows along the x-axis and columns along the y-axis. The number of nozzles 210 may be equal to or larger than the number of coating areas. For example, as illustrated in FIG. 1, four nozzles 210 are provided for four coating areas C, but the numbers and arrangement thereof are not limited thereto.

In detail, the plurality of nozzles 210 may be arranged to correspond to a shape of an arrangement of the plurality of coating areas C on the substrate 900. In an exemplary embodiment, a gap distance between two nozzles 210 adjacent to each other along the x-axis may be equal to or smaller than the gap distance between two coating areas C adjacent to each other along the x-axis. Therefore, when the length of each nozzle 210, e.g., a length of an opening in each nozzle 210, along the x-axis equals a width of the coating area C along the x-axis, each nozzle 210 is completely aligned with and overlaps the width of the corresponding coating area C.

Further, in an exemplary embodiment, if the plurality of coating areas C is arranged in the form of an n×m matrix, the plurality of nozzles 210 may also be arranged in the form of an n×m matrix. As illustrated in FIG. 1, the n×m matrix of the nozzles 210 may not overlap the entire n×m matrix of the coating areas C. For example, as illustrated in FIG. 1, the 2×2 matrix of nozzles 210 may be arranged above the 2×2 matrix of coating areas C, such that two nozzles 210 may be aligned with a first coating area C in each row of the two rows of the coating areas C, but the numbers and arrangement thereof are not limited thereto.

In detail, as illustrated in FIG. 1, the plurality of nozzles 210, i.e., a first nozzle 210a, a second nozzle 210b, a third nozzle 210c, and a fourth nozzle 210d, may be arranged to correspond to the plurality of coating areas C arranged on the substrate 900, i.e., a first coating area C1, a second coating area C2, a third coating area C3, and a fourth coating area C4. That is, if the first coating area C1 is positioned in the second row and second column of the matrix in the form of which the plurality of coating areas C are arranged, the first nozzle 210a may be positioned in the second row and second column of the matrix in the form of which the plurality of nozzles 210 are arranged. If the second coating area C2 is positioned in the second row and first column of the matrix in the form of which the plurality of coating areas C are arranged, the second nozzle 210b may be positioned in the second row and first column of the matrix in the form of which the plurality of nozzles 210 are arranged. If the third coating area C3 is positioned in the first row and second column of the matrix in the form of which the plurality of coating areas C are arranged, the third nozzle 210c may be positioned in the first row and second column of the matrix in the form of which the plurality of nozzles 210 are arranged. Further, if the fourth coating area C4 is positioned in the first row and first column of the matrix in the form of which the plurality of coating areas C are arranged, the fourth nozzle 210d may be positioned in the first row and first column of the matrix in the form of which the plurality of nozzles 210 are arranged.

The support plate 220 may be positioned on an upper portion of the plurality of nozzles 210 to support the plurality of nozzles 210. The support plate may be in a quadrangular, e.g., rectangular, plate shape. Further, the support plate 220 may overlap at least a part of the plurality of nozzles 210. In an exemplary embodiment illustrated in FIG. 1, the support plate 220 overlaps all the nozzles 210, but is not limited thereto. A lower surface of the support plate 220 may be connected to the height adjuster 230 to be described later, and a side surface of the support plate 220 may be connected to a connection arm 310 to be described later. Although not illustrated in the drawing, the support plate 220 may be connected to a storage tank in which the coating liquid L is stored. In detail, the support plate 220 may be connected to the storage tank in which the coating liquid L is stored through a connection line, and a pump in the connection line may supply the coating liquid L into the nozzle 210. In another exemplary embodiment, the storage tank may be accommodated in the support plate 220.

The height adjuster 230 may be installed on the lower surface of the support plate 220. The height adjuster 230 may adjust the height of the nozzle 210. That is, the height adjuster 230 may adjust a distance between the nozzle 210 and the substrate 900 by making the nozzle 210 move upward and downward, i.e., along the z-axis.

A plurality of height adjusters 230 may be provided. The support portion 100 or the nozzle portion 200 may be moved in one direction (arrow direction in an exemplary embodiment illustrated in FIG. 1) by the transport portion 300, and the plurality of height adjusters 230 may be arranged in parallel to the one direction. Further, the plurality of coating areas C on the substrate 900 may be arranged in the form of a matrix having rows that are perpendicular to the one direction and columns that are parallel to the one direction, and the number of height adjusters 230 may be equal to or larger than the number of rows that are perpendicular to the one direction. In an exemplary embodiment, the number of height adjusters 230 may be equal to the number of rows that are perpendicular to the one direction, but is not limited thereto. The number of height adjusters 230 may be equal to the number of the coating areas C or the number of nozzles 210, e.g., each nozzle 210 may have a separate corresponding height adjuster 230.

The supply pipe 240 may connect the support plate 220 and the nozzle 210 to each other. In detail, the supply pipe 240 may connect the lower portion of the support plate 220 to the upper portion of the nozzle 210. Since the nozzle 210 moves upward and downward by the height adjuster 230, the supply pipe 240 may be made of a flexible material, and the length of the supply pipe 240 may be long enough to sufficiently cover the upward/downward movement.

A plurality of supply pipes 240 may be provided. In an exemplary embodiment illustrated in FIG. 1, two supply pipes 24 may be connected to one nozzle 210. One of the two supply pipes 240 may be a coating liquid supply pipe 240. The coating liquid supply pipe 240 may be connected to the above-described storage tank to supply the coating liquid L into the nozzle 210. The other of the two supply pipes 240 may be a gas supply pipe. The gas supply pipe may apply pressure to the coating liquid L inside the nozzle 210 through supply of an inert gas into the nozzle 210. If the pressure is applied to the coating liquid L, the coating liquid L in the nozzle 210 may be discharged out of the nozzle 210.

For example, the transport portion 300 may move the support portion 100 or the nozzle portion 200 in one direction. In an exemplary embodiment illustrated in FIG. 1, the one direction may be along arrow direction, i.e., along the y-axis direction. In another example, the transport portion 300 may move both the support portion 100 and the nozzle portion 200. In the case where the transport portion 300 moves both the support portion 100 and the nozzle portion 200, it may make the support portion 100 and the nozzle portion 200 perform relative movement in predetermined coating directions. For example, the transport portion 300 may move the nozzle portion 200 along the (+y) axis and may move the support portion 100 in an opposite direction, i.e., along the (−y) axis in FIG. 1.

The transport portion 300 may include a connection arm 310 and a guide rail 320. The connection arm 310 may be interposed between the support portion 100 or the nozzle portion 200 and the guide rail 320 to connect the support portion 100 or the nozzle portion 200 to the guide rail 320. In an exemplary embodiment illustrated in FIG. 1, the connection arm 310 is interposed between the support plate 220 of the nozzle portion 200 and the guide rail 320 to connect the support plate 220 and the guide rail 320, but is not limited thereto. The connection arm 310 may be formed to be perpendicular to the one direction and to extend in parallel to one surface of the support portion 100. The guide rail 320 may be positioned at least on one side of the support portion 100. In an exemplary embodiment illustrated in FIG. 1, the guide rail 320 is formed at both sides of the support portion 100, but is not limited thereto, e.g., the guide rail 320 may be formed only at one side of the support portion 100. The guide rail 320 may be formed to extend in the one direction to guide the support portion 100 or the nozzle portion 200 in the one direction.

Referring to FIG. 3, the coating device according to an embodiment may further include the control portion 400. Although not illustrate in FIG. 1, the control portion 400 may be integrally formed with the support portion 100, the nozzle portion 200, or the transport portion 300. Alternatively, the control portion 400 may be formed separately, e.g., spaced apart, from the support portion 100, the nozzle portion 200, and the transport portion 300.

The control portion 400 may control the support portion 100, the nozzle portion 200, and the transport portion 300. In an exemplary embodiment, the control portion 400 may control the transport portion 300 to move the support portion 100 or the nozzle portion 200 at a constant speed in the one direction, e.g., along the y-axis. Further, the control portion 400 may control the respective nozzles 210 that correspond to the respective coating areas C to apply the coating liquid L to the respective coating areas C. Further, if the respective nozzles 210 that correspond to the respective coating areas C overlap the respective coating areas C, the control portion 400 may control the respective nozzle 210 to descend and to apply the coating liquid L to the respective coating areas C. In an exemplary embodiment illustrated in FIG. 1, the control portion 400 may control the first nozzle 210a that corresponds to the first coating area C1 to apply the coating liquid L to the first coating area C1, control the second nozzle 210b that corresponds to the second coating area C2 to apply the coating liquid L to the second coating area C2, control the third nozzle 210c that corresponds to the third coating area C3 to apply the coating liquid L to the third coating area C3, and control the fourth nozzle 210d that corresponds to the fourth coating area C4 to apply the coating liquid L to the fourth coating area C4. That is, the control portion 400 may control each nozzle 210 to apply the coating liquid L to each coating area in a one-to-one manner.

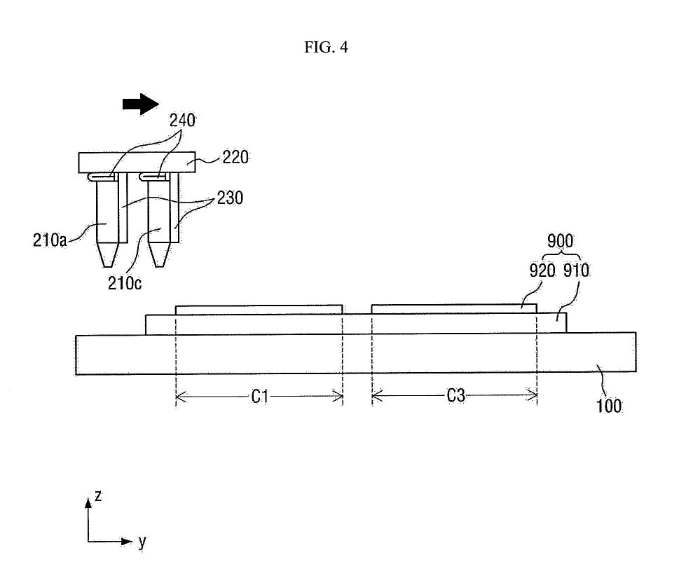

Hereinafter, a coating method according to an embodiment will be described with reference to FIGS. 4 to 8. FIGS. 4 to 8 are side views explaining a coating method according to an embodiment. For convenience in explanation, same reference numerals are used for elements that are substantially the same as the respective elements illustrated in FIGS. 1 and 2, and a duplicate explanation thereof wine omitted.

First, referring to FIG. 4, the substrate 900 may be seated on the support portion 100. The substrate 900 may be seated on the support portion 100 by a transport robot, other transport rails, or manual operation of a worker. The substrate 900 that is seated on the support portion 100 may be adsorbed and fixed to the support portion 100 by a vacuum pump that is connected to the support portion 100.

The nozzle portion 200 may be positioned on, e.g., above, an upper portion of the edge of the support portion 100. In this case, the nozzle 210 of the nozzle portion 200 may be preset to facilitate the discharge of the coating liquid L and to make the thickness of the discharged coating liquid L uniform. In an exemplary embodiment, before the nozzle 210 is moved to the coating area C, the nozzle 210 may pre-dispense a small amount of coating liquid L to remove a pore in the nozzle 210. Further, after the nozzle 210 pre-dispenses the small amount of coating liquid L, an end portion of the nozzle 210, e.g., which may be stained with the coating liquid L, may be wiped.

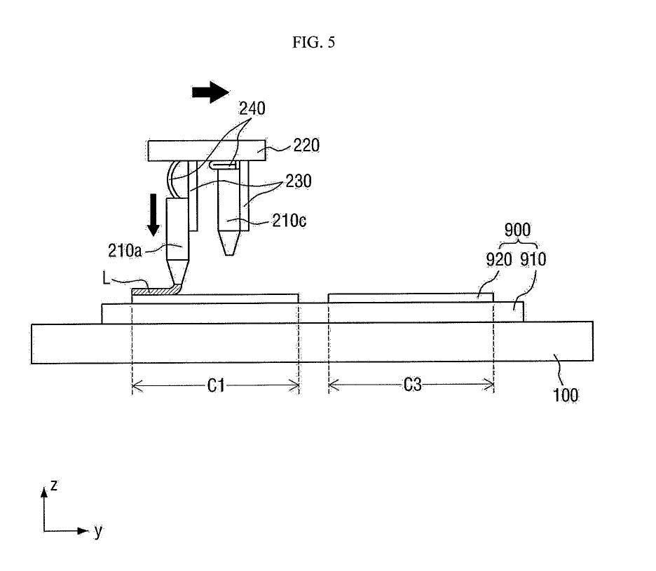

Next, referring to FIG. 5, as the nozzle portion 200 is moved in the one direction, i.e., in the arrow direction along the y-axis in FIG. 5, the nozzle 210 of the nozzle portion 200 may be positioned on, e.g., above, the coating area C. At this time, the nozzle 210 that corresponds to the coating area C may descend through the height adjuster 230 to apply the coating liquid L to the coating area C. In an exemplary embodiment illustrated in FIG. 5, both the first nozzle 210a and the third nozzle 210c are positioned on the first coating area Cl. However, only the first nozzle 210a that corresponds to the first coating area C1 may descend through the height adjuster 230 to apply the coating liquid L to the first coating area C1. At this time, the height adjuster 230 may adjust the thickness of the coating liquid L that is applied to the first coating area C1 to be uniform by properly adjusting the height of the first nozzle 210a. Specifically, the height adjuster 230 may adjust the height of the first nozzle 210a to the lowest level at the end portion of the first coating area C1 to form a bead of the coating liquid L on the first coating area C1, and then may adjust the height of the first nozzle 210a to be a little higher to apply the coating liquid L to the first coating area C1 with a desired thickness while the first nozzle 210a is moved in the one direction.

Although not illustrated in FIG. 5, a second nozzle 210b and a fourth nozzle 210d may be positioned on the second coating area C2 that is positioned in the same row as the first coating area C1. Although both the second nozzle 210b and the fourth nozzle 210d are positioned on the second coating area C2, only the second nozzle 210b that corresponds to the second coating area C2 may descend through the height adjuster 230 and apply the coating liquid L to the second coating area C2. At this time, the height adjuster 230 may adjust the thickness of the coating liquid L that is applied to the second coating area C2 uniform by properly adjusting the height of the second nozzle 210b.

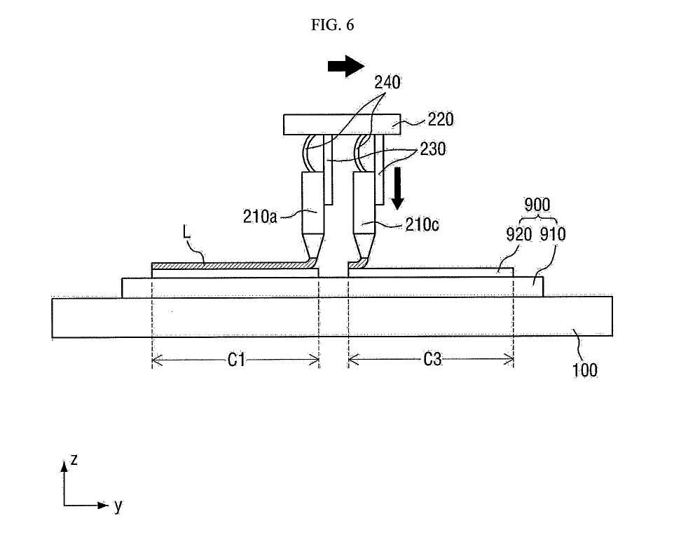

Next, referring to FIG. 6, as the nozzle portion 200 is continuously moved in the one direction, the third nozzle 210c may be positioned on, e.g., above, the third coating area C3. That is, if the third nozzle 210c that corresponds to the third coating area C3 is positioned on the third coating area C3, the third nozzle 210c may descend through the height adjuster 230 to apply the coating liquid L to the third coating area C3. That is, while the first nozzle 210a that is positioned above the first coating area C1 continues applying the coating liquid L to the first coating area C1, the third nozzle 210c above the third coating area C3 may begin applying the coating liquid L to the third coating area C3. At this time, the height adjuster 230 may adjust the thickness of the coating liquid L that is applied to the third coating area C3 to be uniform by properly adjusting the height of the third nozzle 210c.

Although not illustrated in FIG. 6, as the nozzle portion 200 is continuously moved in the one direction, the fourth nozzle 210d may be positioned on the fourth coating area C4 that is positioned in the same row as the third coating area C3. That is, if the fourth nozzle 210d that corresponds to the fourth coating area C4 is positioned on the fourth coating area C4, the fourth nozzle 210d may descend through the height adjuster 230 to apply the coating liquid L to the fourth coating area C4. That is, the second nozzle 210b that is positioned on the second coating area C2 may apply the coating liquid L to the second coating area C2, and the fourth nozzle 210d that is positioned on the fourth coating area C4 may apply the coating liquid L to the fourth coating area C4. At this time, the height adjuster 230 may adjust the thickness of the coating liquid L that is applied to the fourth coating area C4 uniform by properly adjusting the height of the fourth nozzle 210d.

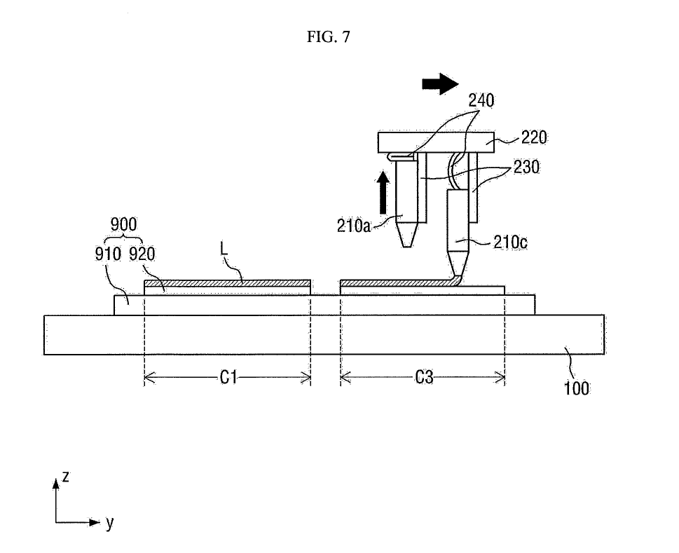

Next, referring to FIG. 7, as the nozzle portion 200 is continuously moved in the one direction, the first nozzle 210a and the third nozzle 210c may be positioned above the third coating area C3. Although both the first nozzle 210a and the third nozzle 210c are positioned above the third coating area C3, only the third nozzle 210c that corresponds to the third coating area C3 may descend to apply the coating liquid L to the third coating area C3. In other words, the first nozzle 210a that does not corresponds to the third coating area C3 may ascend to return to its original state after completing the discharge of the coating liquid L to the first coating area C1 without applying any coating to the third coating area C3.

Although not illustrated in FIG. 7, the second nozzle 210b and the fourth nozzle 210d may be positioned on the fourth coating area C4 that is positioned in the same row as the third coating area C3. Although both the second nozzle 210b and the fourth nozzle 210d are positioned on the fourth coating area C4, only the fourth nozzle 210d that corresponds to the fourth coating area C4 may descend to apply the coating liquid L to the fourth coating area C43. The second nozzle 210b that does not corresponds to the fourth coating area C4 may ascend to return to its original state after completing the discharge of the coating liquid L to the second coating area C2.

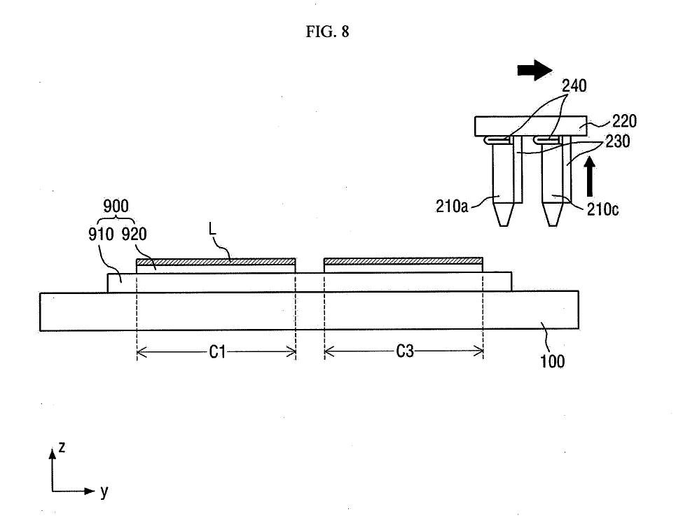

Next, referring to FIG. 8, after the nozzle portion 200 passes through the whole coating area C through continuous movement in the one direction, the nozzle portion 200 may be positioned on a non-coating area N or on the support portion 100. That is, the third nozzle 210c may ascend to return to its original state after completing the discharge of the coating liquid L to the third coating area C3. Although not illustrated in FIG. 8, the fourth nozzle 210d may ascend to return to its original state after completing the discharge of the coating liquid L to the fourth coating area C4. Accordingly, all the nozzles 210 are in an ascending state to complete the coating process. In an exemplary embodiment, the plurality of nozzles 210, which have completed the coating process, may be safely kept after a cleaning process is performed. In another exemplary embodiment, the plurality of nozzles 210, which have completed the coating process, may be moved in an opposite direction to the one direction to apply the coating liquid L to another substrate.

As described above, according to the coating device and the coating method of the example embodiments, the coating liquid L can be selectively applied to the plurality of coating areas C on the substrate 900. As such, the coating efficiency may increase in terms of materials and time. Further, since the process of removing the coating liquid L applied to the non-coating areas N can be omitted, damage to the device layer 920 may prevented.

In contrast, conventionally, when the coating liquid L is applied to an entire surface of a substrate using a single slit nozzle, i.e., without selective application to predetermined areas, the coating liquid L may also be applied to the non-coating areas N. Accordingly, waste of materials occurs. Further, the coating liquid L applied to the non-coating areas N may require removal, e.g., by etching through plasma processing, thereby subjecting the device layer 920 on the coating areas C adjacent to the non-coating areas N to unnecessary stress and potential damage.

In addition, according to the coating device and the coating method of the example embodiments, the coating liquid L is applied to one coating area using a preset nozzle 210 only, thereby improving uniformity of the thickness of the coating liquid L on the coating area C. In contrast, if the coating liquid L is discharged through a single slit nozzle onto an entire substrate, i.e., via scanning of the substrate, it may be difficult to properly control the coating liquid L in the single nozzle, thereby causing application of the coating liquid L with a non-uniform thickness. In particular, if the single slit nozzle discharges the coating liquid L by alternately passing through a coating area C and a non-coating area N, the thickness of the coating liquid L in a middle region may be thicker than a desired thickness.

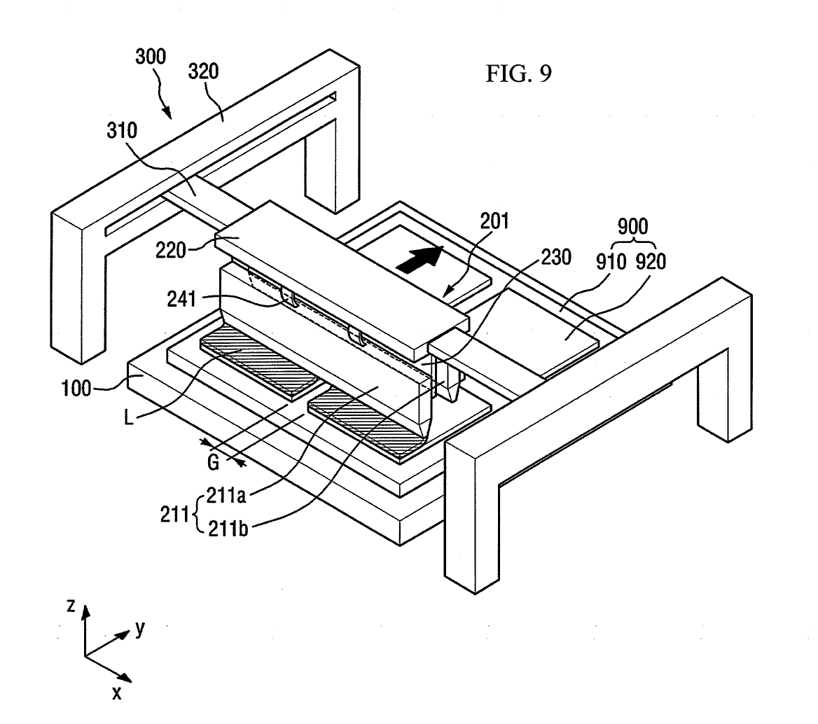

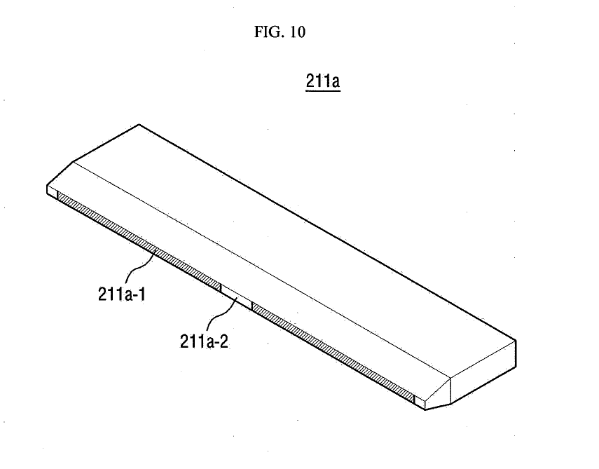

Hereinafter, referring to FIGS. 9 and 10, a coating device according to another embodiment will be described. FIG. 9 is a perspective view illustrating a coating device according to another embodiment, and FIG. 10 is an enlarged perspective view of a nozzle of the coating device of FIG. 9. For convenience in explanation, the same reference numerals are used for elements that are substantially the same as the respective elements illustrated in FIGS. 1 and 2, and a duplicate explanation thereof will be omitted.

Referring to FIG. 9, a number of nozzles 211 may be equal to a number of rows along the x-axis, which are perpendicular to the one direction, of the matrix in the form of which the plurality of coating areas C are arranged. That is, if the number of rows, which are perpendicular to the one direction, of the matrix in the form of which the plurality of coating areas C are arranged is n, the nozzle portion 201 may be provided with n nozzles 211. For example, in FIG. 9, the nozzles 211 may include a first nozzle 211a and a second nozzle 211b, and a length of the first nozzle 211a and a length of the second nozzle 211b may be equal to or larger than a total length of the rows that are perpendicular to the one direction: Accordingly, in comparison to the coating device in FIG. 1, a number of supply pipes 241 may be reduced, e.g., the number of the supply pipes 241 may be reduced by 2.

Referring to FIG. 10, the nozzle 211 may include a discharge port 211a-1 that corresponds to the coating area C. Here, the discharge port 211a-1 may be formed to extend in a predetermined direction. For example, as illustrated in FIG. 10, the extended length of the discharge port 211a-1 along the x-axis may correspond to a total width of the coating area C along the x-axis, e.g., a total width of the two coating areas C along the x-axis and the gap therebetween. That is, the length of the discharge port 211a-1 may be equal to or smaller than the width of the coating area C. Further, the nozzle 211 may include a barrier film 211a-2 that corresponds to the non-coating area N, e.g., to the gap between two coating areas C adjacent to each other along the x-axis. In an exemplary embodiment illustrated in FIG. 10, the length of the barrier film 211a-2 along the x-axis may be equal to or larger than a width of a gap G along the x-axis.

As described above, the number of nozzles 211 in the embodiment of FIGS. 9-10 may be reduced in comparison to the coating device according to the embodiment of FIGS. 1-2, thereby reducing nozzle manufacturing costs. Further, since a smaller number of nozzles 211 is controlled, a number of supply pipes is reduced and overall control may be easily performed.

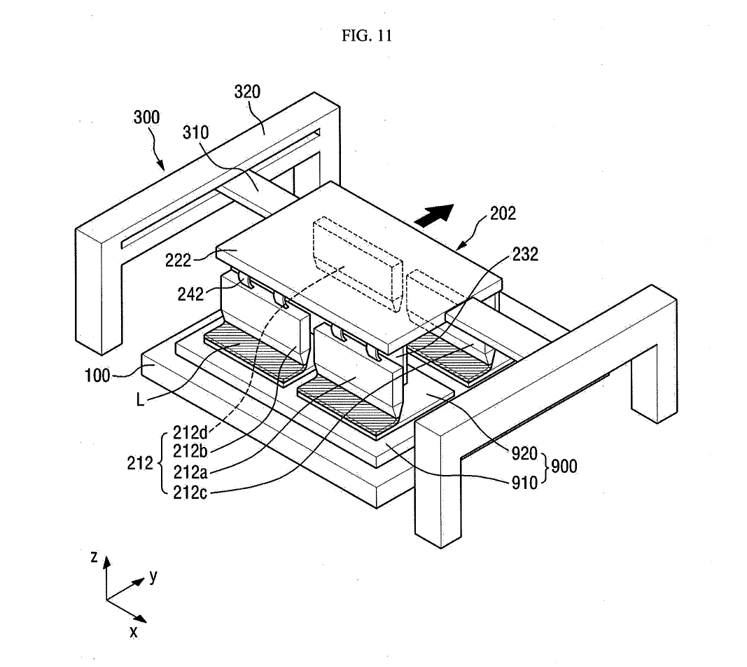

Hereinafter, referring to FIG. 11, a coating device according to still another embodiment will be described. FIG. 11 is a perspective view of a coating device according to still another embodiment. For convenience in explanation, the same reference numerals are used for elements that are substantially the same as the respective elements illustrated in FIGS. 1 and 2, and a duplicate explanation thereof will be omitted.

Referring to FIG. 11, a coating device according to still another embodiment may include a nozzle portion 202 of a different type. That is, among a plurality of nozzles 212 of the nozzle portion 202, a distance between a first nozzle 212a and a third nozzle 212c and/or a distance between a second nozzle 212b and a fourth nozzle 212d may be increased. In an exemplary embodiment, the distance between the first nozzle 212a and the third nozzle 212c and the distance between the second nozzle 212b and the fourth nozzle 212d may be equal to the distance between center portions of two adjacent rows of the matrix in the form of which the plurality of coating areas C are arranged. In other words, as illustrated in FIG. 11, each nozzle 212 may be aligned above a corresponding coating area C, so each nozzle 212 is positioned only above the corresponding coating area C during the entire coating process. Accordingly, a size of a support plate 222, the position of a height adjuster 232, and the position of a supply pipe 242 may be changed. Accordingly, the coating liquid L may be applied to all the coating areas C at the same time.

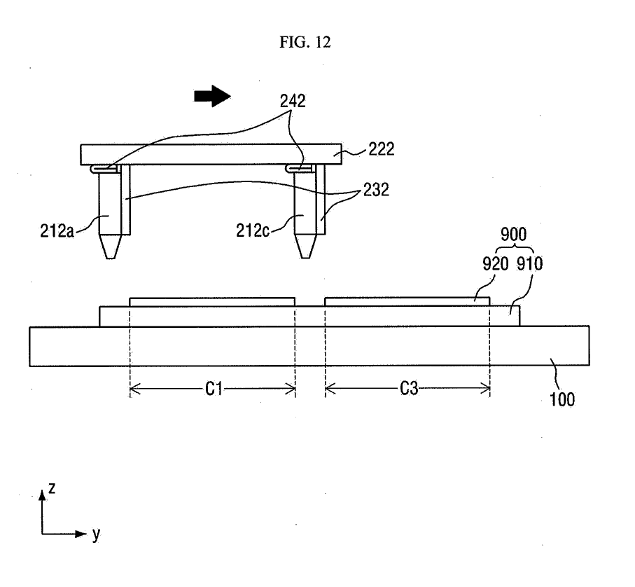

Hereinafter, referring to FIGS. 12 to 14, a coating method according to another embodiment will be described. FIGS. 12 to 14 are side views of stages in a coating method according to another embodiment. For convenience in explanation, same reference numerals are used for elements that are substantially the same as the respective elements illustrated in FIG. 11, and a duplicate explanation thereof will be omitted.

First, referring to FIG. 12, the substrate 900 may be seated on the support portion 100. The substrate 900 that is seated on the support portion 100 may be adsorbed and fixed to the support portion 100 by a vacuum pump that is connected to the support portion 100.

The nozzle portion 202 may be positioned on, e.g., above, an upper portion of the edge of the support portion 100. In this case, the nozzle 212 of the nozzle portion 202 may be preset to facilitate the discharge of the coating liquid L and to make the thickness of the discharged coating liquid L uniform. For example, each nozzle 212 may be positioned just at the edge of, e.g., just before, a corresponding coating area C.

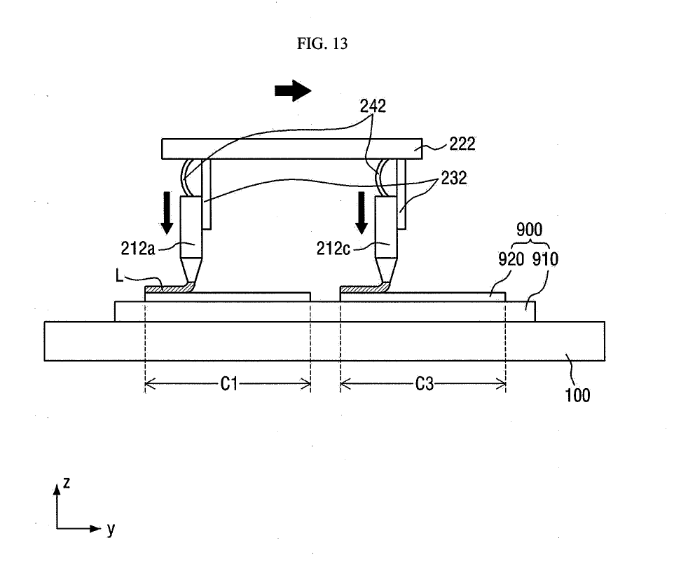

Next, referring to FIG. 13, as the nozzle portion 202 is moved in the one direction, i.e., arrow direction in FIG. 13, all nozzles 212 of the nozzle portion 202 may be positioned on all coating areas C. At this time, all nozzles 212 may descend through the height adjuster 232 to apply the coating liquid L to all coating areas C, e.g., simultaneously. In an exemplary embodiment illustrated in FIG. 13, the first nozzle 212a that is positioned on the first coating area C1 and the third nozzle 212c that is positioned on the third coating area C3 may descend to apply the coating liquid L to the first coating area C1 and the third coating area C3, respectively. Further, although not illustrated in FIG. 13, the second nozzle 212b that is positioned on the second coating area C2 and the fourth nozzle 212d that is positioned on the fourth coating area C4 may descend to apply the coating liquid L to the second coating area C2 and the fourth coating area C4, respectively.

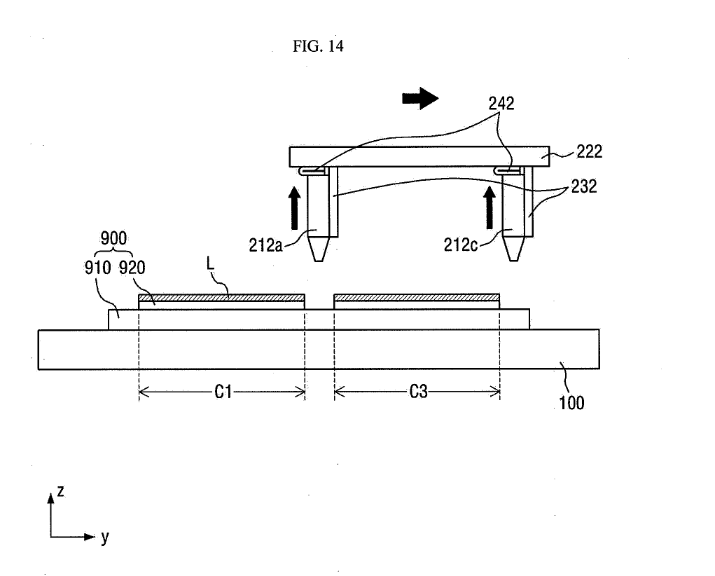

Next, referring to FIG. 14, after the nozzle portion 202 passes through the whole coating areas C through continuous movement in the one direction, all the nozzle 212 may ascend to return to their original states. Therefore, as described above, the coating liquid L is applied to all the coating areas C at the same time, and thus the efficiency of the coating process may be increased.

According to the example embodiments, by selectively applying a coating liquid onto a plurality of coating areas on a substrate, efficiency in terms of material may be improved. Further, since the process of removing the coating liquid applied to the non-coating areas may be omitted, a potential damage to the device layer on the coating areas may be prevented. Further, the thickness of the coating liquid applied to the coating areas of the substrate may be uniformly controlled.

In contrast, when a coating liquid is conventionally applied to an entire surface of a substrate, which includes a plurality of coating areas and non-coating areas, via a single slit nozzle, the coating liquid may be applied to the non-coating areas as well. Therefore, since the coating liquid is applied to unnecessary areas, waste of materials occurs. Further, the coating liquid applied to the non-coating areas may require removal by etching through plasma processing, thereby causing potential damage to a device layer on the coating areas adjacent to the non-coating areas. Further, if the coating liquid is controlled to be discharged from a nozzle only through the single slit nozzle, which scans the substrate and passes through the coating areas, it may be difficult to properly control the coating liquid inside the nozzle, thereby causing non-uniform thickness of the coating liquid. In particular, if the single slit nozzle discharges the coating liquid as the nozzle alternately passes through the coating area and the non-coating area, the thickness of the coating liquid which is initially applied to the coating area that is positioned in midway may become thicker than a desired thickness.

Although preferred embodiments of the example embodiments have been described for illustrative purposes, those skilled in the art will appreciate that various modifications, additions and substitutions are possible, without departing from the scope and spirit of the invention as disclosed in the accompanying claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the example embodiments as set forth in the following claims.

What is claimed is:

1. A coating method, the method comprising:
arranging a nozzle portion with a plurality of nozzles above a substrate with a plurality of coating areas;
moving the substrate or the nozzle portion in a first direction; and
applying a coating liquid to respective coating areas through corresponding nozzles.

2. The coating method as claimed in claim 1, wherein the plurality of coating areas are arranged in a matrix pattern having columns in the first direction and rows in a second direction perpendicular to the first direction, a number of nozzles being equal to or larger than a number of the rows in the matrix pattern.

3. The coating method as claimed in claim 2, wherein the number of nozzles is equal to the number of the coating areas.

4. The coating method as claimed in claim 2, wherein the number of nozzles is equal to the number of the in the matrix pattern, the nozzle including a discharge port corresponding to the coating area.

5. The coating method as claimed in claim 1, wherein applying the coating liquid includes:
descending the nozzles toward the coating areas; and
applying the coating liquid to the respective coating areas if the respective nozzles that correspond to the respective coating areas overlap the respective coating areas.

6. The coating method as claimed in claim 1, wherein applying the coating liquid includes applying the coating liquid to all the coating areas at the same time.
